(19) United States
(12) Patent Application Publication
(10) Pub. No.: US 2015/0260946 A1
(43) Pub. Date: Sep. 17, 2015

(54) Driving Corrective Vision System for the Visually Impaired

(71) Applicant: Celestine Wenegieme, JR., Ridge, VA (US)

(72) Inventor: Celestine Wenegieme, JR., Ridge, VA (US)

(21) Appl. No.: 14/643,546

(22) Filed: Mar. 10, 2015

Related U.S. Application Data
(60) Provisional application No. 61/951,863, filed on Mar. 12, 2014.

(51) Int. Cl. G02B 7/02; G02B 27/02; G02B 27/04; B60R 1/08

(52) U.S. Cl. CPC G02B 7/023; B60R 1/08; G02B 27/022; G02B 27/028; G02B 27/04

(57) ABSTRACT

A driving corrective vision system for the visually impaired used to correct the vision of a driver who lost or misplaced their glasses. The driving corrective vision system for the visually impaired includes a front corrective lens, a rear view lens, a driver-side lens, and a passenger side lens. The front corrective lens is connected to a driver side visor, correcting the driver's vision ahead of the vehicle. The rear view lens is attached to the rear view mirror, correcting the driver's vision behind the vehicle. The driver-side lens and the passenger side lens correct the driver's vision along sides of the vehicle and are attached to the respective mirror of the vehicle, correcting vision peripherally. Each of the front corrective lens, the rear view lens, the driver-side lens and the passenger side lens are optically configured to have a focal point at the location of the driver's eyes.

The current application claims a priority to the U.S. Provisional Patent application Ser. No. 61/951,863 filed on Mar. 12, 2014.

### FIELD OF THE INVENTION

The present invention relates generally to a driving corrective vision system for the visually impaired. More specifically, the present invention relates to an array of lenses to be positioned on a vehicle to allow a visually impaired user to drive a vehicle having lost or misplaced their glasses.

### BACKGROUND OF THE INVENTION

Many people use corrective lenses to improve their vision. Modern methods of improving a person's vision include glasses, contact lenses, and surgeries. These methods modify and change the position of the focal point of the lens within the person's eyes.

The focal point can be affected through conditions such as nearsightedness, farsightedness, or astigmatism. These conditions describe different shapes of the eye in which the person afflicted can only see things near or far clearly or sees objects blurry. Glasses and contact lenses correct the focal point to the proper receptors within the wearer's eyes. Glasses and contact lenses are required for drivers affected by these conditions such that the drivers will be able to see the signals, signs, pedestrians, hazards, and other vehicles on roadways clearly, to react in a timely manner. People often misplace their glasses or drop their contacts preventing the person from being able to drive. Surgeries are an alternative to wearing glasses or contacts lens; however, corrective surgeries are often expensive and unaffordable for some people.

Therefore, it is an object of the present invention to introduce a system for an array of lenses which would allow a driver with vision impairments to drive having lost or misplaced their glasses or contact lenses. The lenses are attached around the cabin and on the side view mirrors of a vehicle to allow the visually impaired driver to see clearly from the driver's seat. The lenses may be removed easily such that non-vision impaired persons may operate the same vehicle quickly when necessary.

### BRIEF DESCRIPTION OF THE DRAWINGS

FIG. 1 is a schematic view of the simplest embodiment of the present invention in a first operative configuration.

FIG. 2 is a schematic view of the simplest embodiment of the present invention in a second operative configuration.

FIG. 3 is a schematic view of the simplest embodiment of the present invention in a retracted storage configuration.

FIG. 4 is a top schematic view of the corrective refraction provided by the present invention including a rear view lens, a driver-side lens, and a passenger side lens.

FIG. 5 is a detailed view for the position of the focal points for the front corrective lens, the rear view lens, the driver-side lens, and the passenger side lens.

FIG. 6 is an exploded view of an attachment mechanism between the rear view lens and a rear view mirror.

FIG. 7 is a perspective view of the rear view lens attached to the rear view mirror.

FIG. 8 is an exploded view of an attachment mechanism between the driver-side lens and a driver-side mirror.

FIG. 9 is a perspective view of the driver-side lens attached to the driver-side mirror.

FIG. 10 is an exploded view of an attachment mechanism between the passenger side lens and a passenger side mirror.

FIG. 11 is a perspective view of the passenger side lens attached to the passenger side mirror.

### DETAIL DESCRIPTIONS OF THE INVENTION

All illustrations of the drawings are for the purpose of describing selected versions of the present invention and are not intended to limit the scope of the present invention.

The present invention is a driving corrective vision system for the visually impaired, which corrects the vision of a user to allow the user to operate a vehicle when the user misplaces or loses their glasses or contact lenses. Most states require visually impaired drivers to wear corrective lenses while driving to increase safety on the roads.

The present invention is mounted at various positions on a vehicle 5 to provide correction to the user's vision around the vehicle 5. The preferred vehicle 5 is an automobile; however the present invention is capable of being adapted to trucks, recreational vehicles, etc.

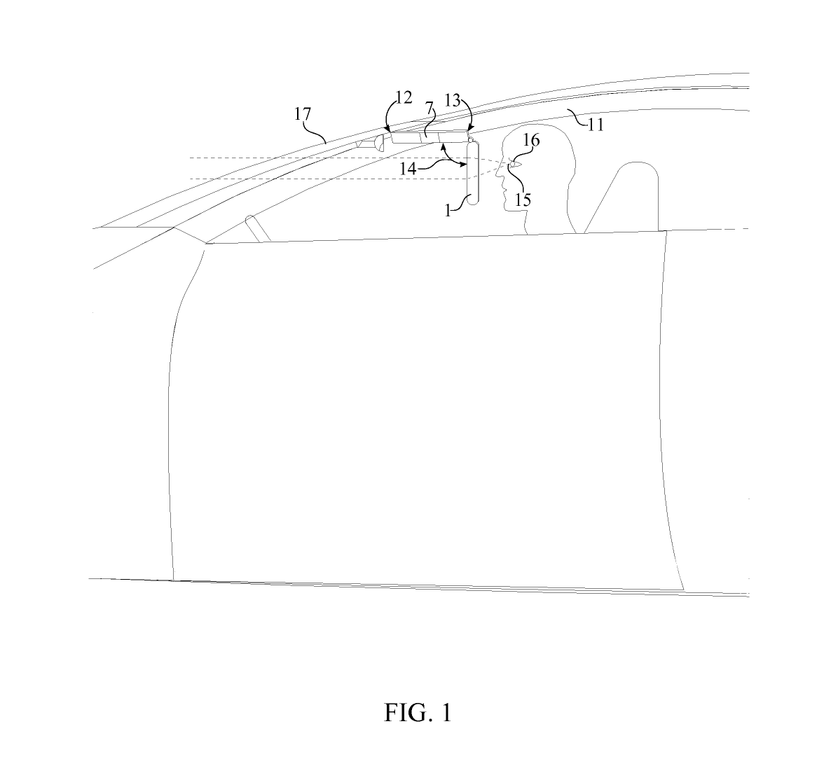

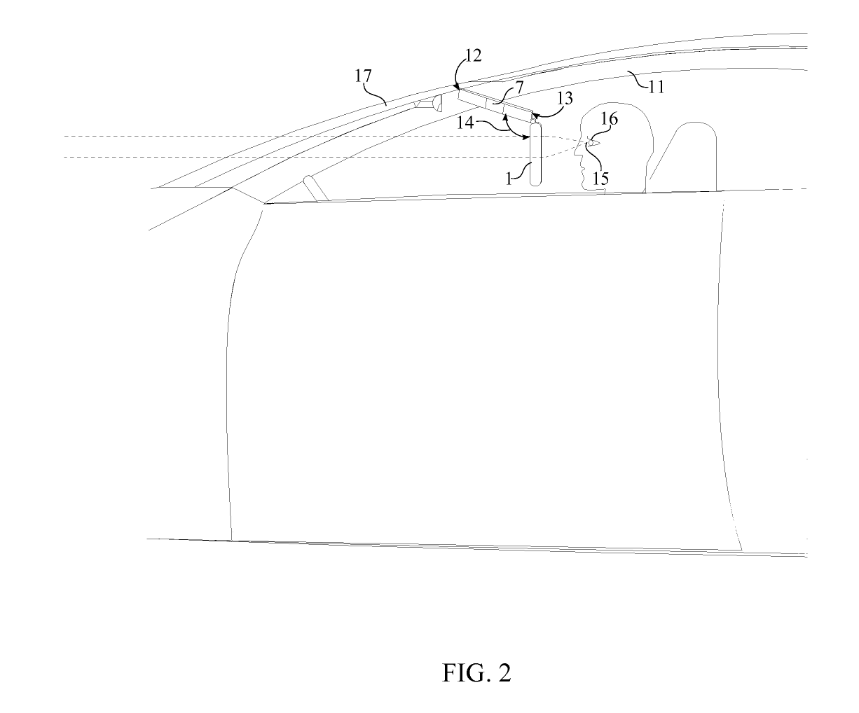

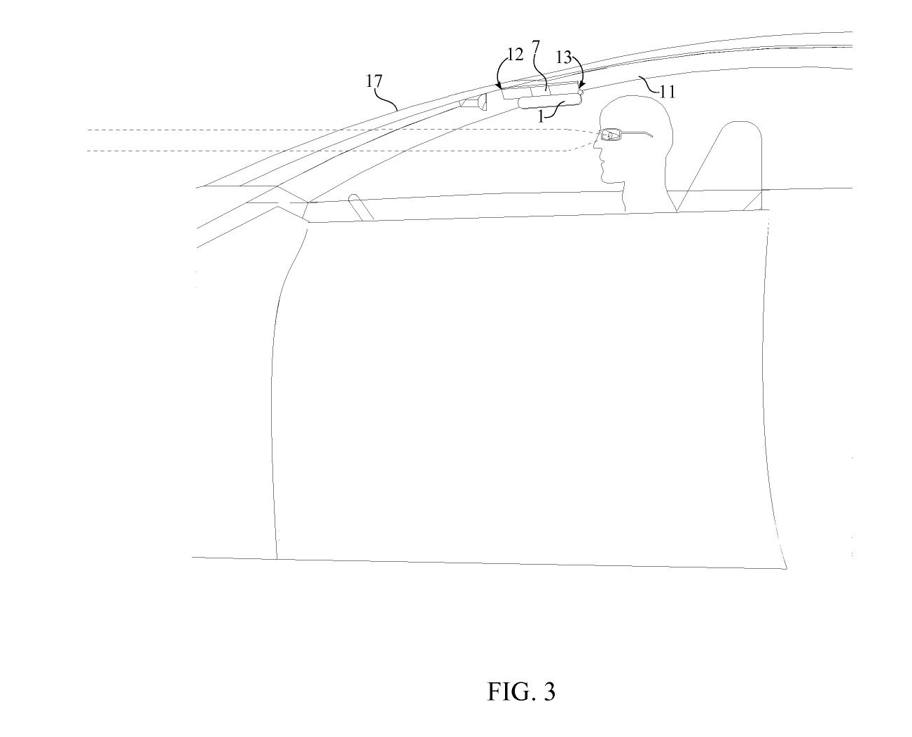

In accordance to FIG. 1, FIG. 2, and FIG. 3, the present invention comprises a front corrective lens 1 and a driver-side visor 7. The front corrective lens 1 is matched to a prescription of the driver to provide clear view ahead of the vehicle 5. The driver-side visor 7 provides a mounting point in front of the driver, wherein the front corrective lens 1 is adjacently positioned to the driver-side visor 7. The driver-side visor 7 comprises a horizontal rotation axis 12 and a distal edge 13. The horizontal rotation axis 12 is the pivoting axis which allows the user to angle the driver-side visor 7 between the roof of the vehicle 5 and a windshield 17 of the vehicle 5. The horizontal rotation axis 12 and the distal edge 13 are positioned opposite to each other across the driver-side visor 7. The front corrective lens 1 is hingedly connected to the driver-side visor 7 along the distal edge 13 such that the front corrective lens 1 is rotatable about the distal edge 13. The front corrective lens 1 is optically configured to position a focal point 15 of the corrective lens at a location of the driver's eyes 16, such that the user can see clearly in front of the vehicle 5.

In a first operative configuration of the front corrective lens 1 and the driver-side visor 7, the driver-side visor 7 is pressed against an interior roof 11 of the vehicle 5, as shown in FIG. 1. The front corrective lens 1 is oriented at an optimal visibility angle 14 for driver visibility with respect to the driver-side visor 7, wherein the optimal visibility angle 14 is a right angle. This configuration allows the user to view in front of the vehicle 5 clearly while having only the driver-side visor 7 retracted providing the driver with an unobstructed view. However, at certain times of the day the sun is positioned in a manner which is blinding to the driver. At these times, the front corrective lens 1 and the driver-side visor 7 are in a second operative configuration of the present invention. In the second operative configuration, the driver-side visor 7 is oriented at an offset angle from the interior roof 11 such that the driver-side visor 7 provides shade from the sun allowing the user to see in front of the vehicle 5, as shown in FIG. 2. The front corrective lens 1 is then oriented at the optimal visibility angle 14 to the driver-side visor 7, wherein the optimal visibility angle 14 is greater than ninety degrees. This orientation allows the front corrective lens 1 to be positioned in a manner where the driver can see in front of the vehicle 5 clearly.

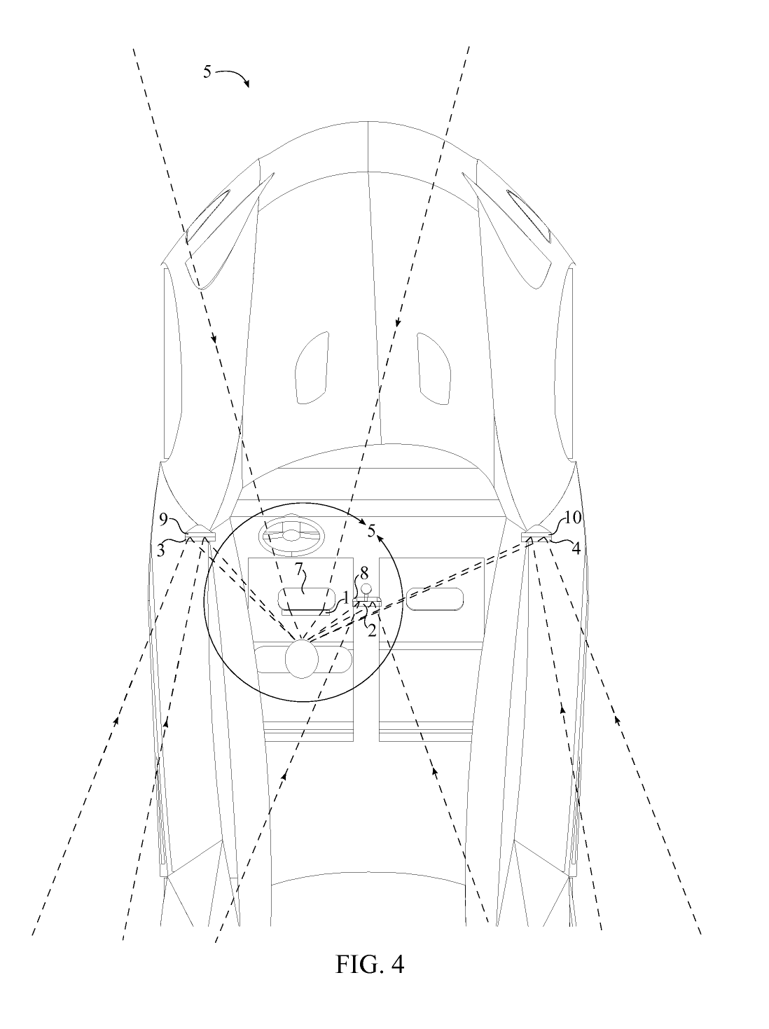

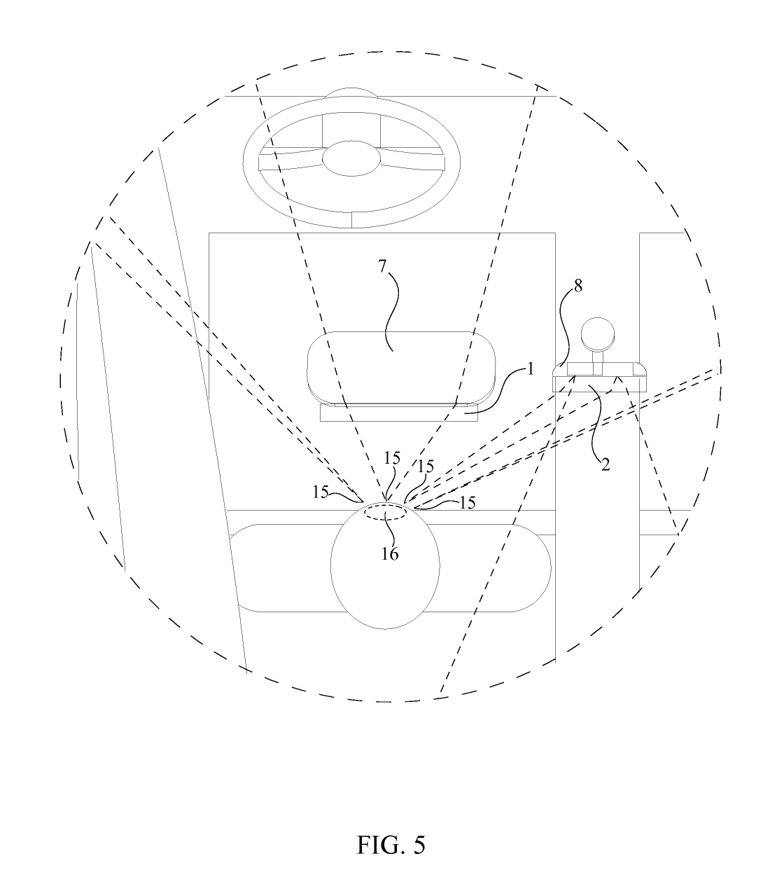

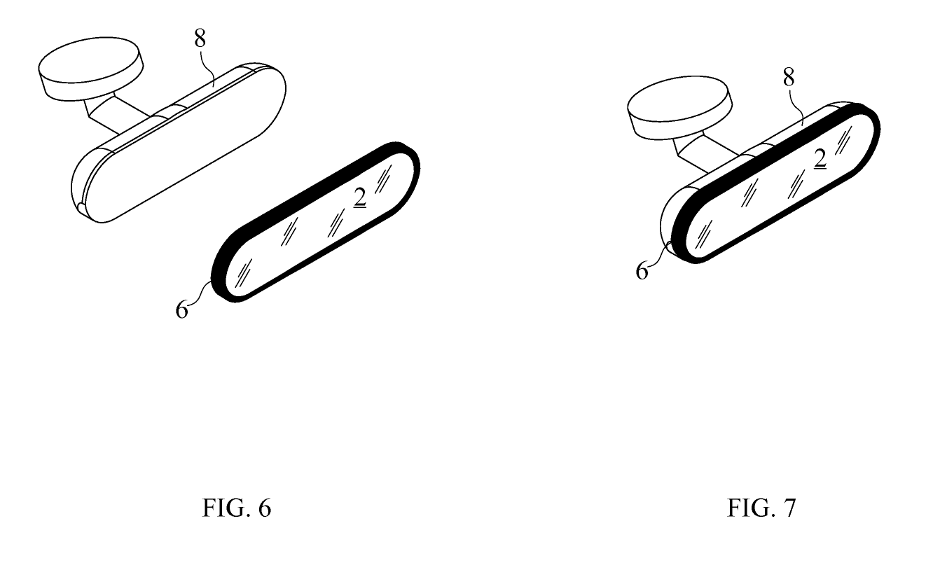

In some embodiments of the present invention, the present invention further comprises a rear view lens 2, a driver-side lens 3, and a passenger side lens 4, as shown in FIG. 4. The rear view lens 2 provides the driver with a clear view behind the vehicle 5. The rear view lens 2 comprises an attachment mechanism 6. The rear view lens 2 is removably mounted onto a rear view mirror 8 of the vehicle 5 through the attachment mechanism 6, as shown in FIG. 6 and FIG. 7. The rear view lens 2 is optically configured to position a focal point 15 of the rear view lens 2 at the location of the driver's eyes 16, as shown in FIG. 4 and further detailed in FIG. 5. This configuration allows the user to see clearly behind the vehicle 5 through a reflection of the rear view mirror 8.

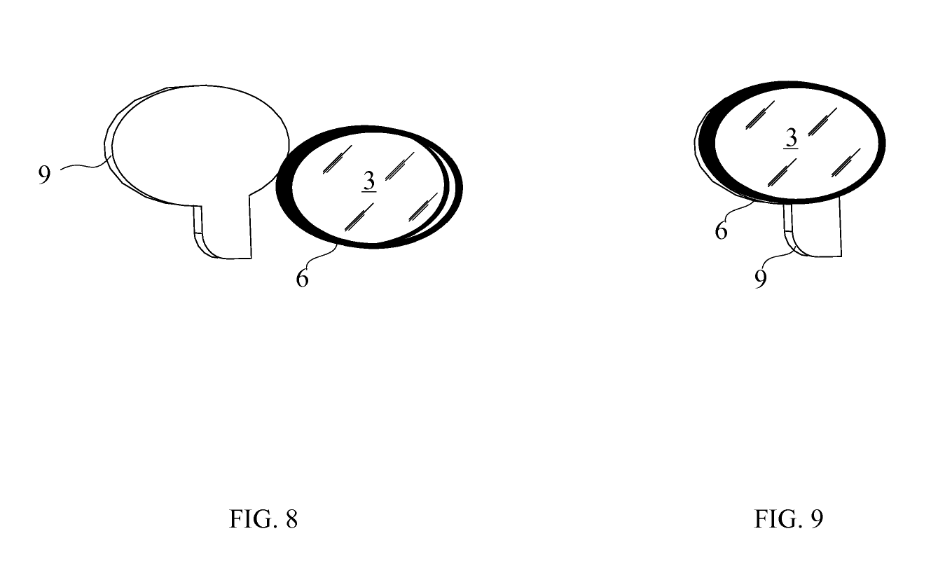

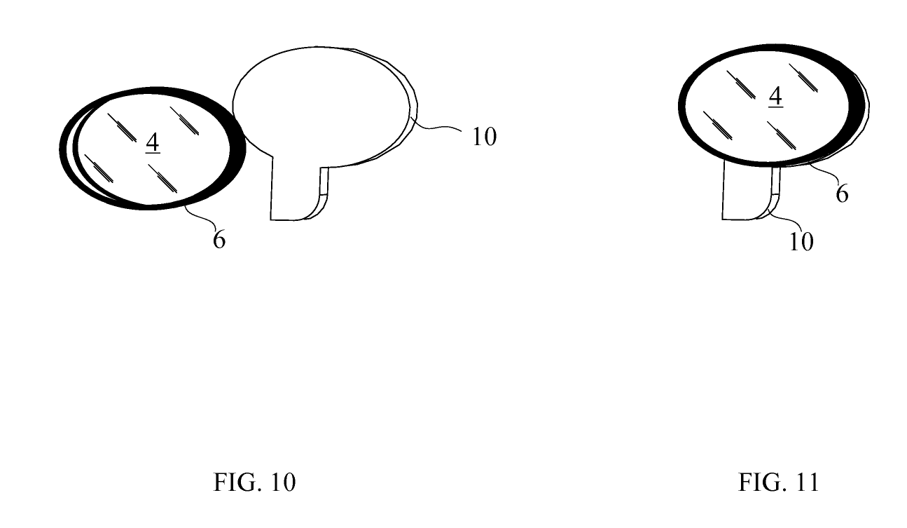

The driver-side lens 3 allows the driver to clearly see peripherally along the exterior driver-side of the vehicle 5. The driver-side lens 3 comprises an attachment mechanism 6. The driver-side lens 3 is removably mounted to a driver-side mirror 9 of the vehicle 5 through the attachment mechanism 6 of the driver-side lens 3, as shown in FIG. 8 and FIG. 9. The driver-side lens 3 is optically configured to position a focal point 15 of the driver-side lens 3 at the location of the driver's eyes 16, as shown in FIG. 4 and further detailed in FIG. 5. Similarly, the passenger side lens 4 comprises an attachment mechanism 6 and is removably mounted onto a passenger side mirror 10 through the attachment mechanism 6 of the passenger side lens 4, as shown in FIG. 10 and FIG. 11. The passenger side lens 4 is optically configured to position a focal point 15 of the passenger side lens 4 at the location of the driver's eyes 16, as shown in FIG. 4 and further detailed in FIG. 5. This configuration allows the user to clearly see peripherally along the exterior of the vehicle 5 on the respective sides of the driver and the passenger.

The attachment mechanism 6 for each of the rear view lens 2, the driver-side lens 3, and the passenger side lens 4 is preferred to be a clip; however, other embodiments of the attachment mechanism 6 include, but are not limited to, a semi-permanent adhesive or any other appropriate means of fastening to the respective mirror of the vehicle 5. The attachment mechanism 6 of the rear view lens 2, the driver-side lens 3, and the passenger side lens 4 is perimetrically connected around the rear view lens 2, the driver-side lens 3, and the passenger side lens 4 respectively. The attachment mechanism 6 of the rear view lens 2, the driver-side lens 3, and the passenger side lens 4 mounts around the perimeter of the respective mirror such that a large area of the reflective surface is not obscured to the driver.

As previously mentioned, the present invention is implemented when a driver loses or misplaces their glasses or contacts. When the driver is in possession of and using their glasses or contacts, the present invention, when in the first operative configuration or in the second operative configuration, obscures the vision of the driver instead of being corrective. In this case, or when a driver does not need vision correction, the front corrective lens 1 and the driver-side visor 7 are in a retracted storage configuration, as detailed in FIG. 3. In the retracted storage configuration, the driver-side visor 7 is pressed against the interior roof 11 of the vehicle 5, and the front corrective lens 1 is pressed against the driver-side visor 7, opposite to the interior roof 11 of the vehicle 5. Additionally, the driver-side lens 3, the passenger side lens 4, and the rear view lens 2 are removed from the respective mirrors. This retracted storage configuration allows any driver in possession of vision corrective apparatuses or drivers who do not need vision correction to operate the vehicle 5 efficiently.

The front corrective lens 1, the rear view lens 2, the driver-side lens 3 and the passenger side lens 4 are preferred to be shatter resistant to promote safety for the driver and passengers within the vehicle 5. The shatter resistant property is a result of the front corrective lens 1, the rear view lens 2, the driver-side lens 3, and the passenger side lens 4 being made from a CR-39, polycarbonate, or other material with similar properties preventing a lens from shattering into pieces when it breaks. This material selection also allows the front corrective lens 1, the rear view lens 2, the driver-side lens 3, and the passenger side lens 4 to be lightweight

Although the invention has been explained in relation to its preferred embodiment, it is to be understood that many other possible modifications and variations can be made without departing from the spirit and scope of the invention as hereinafter claimed.

What is claimed is:

1. A driving corrective vision system for the visually impaired comprises:
a front corrective lens;
a driver-side visor of a vehicle;
the driver-side visor comprises a horizontal rotation axis and a distal edge;
the horizontal rotation axis and the distal edge being positioned opposite to each other across the driver-side visor;
the front corrective lens being hingedly connected along the distal edge; and
the front corrective lens being optically configured to position a focal point of the front corrective lens at a location of the driver's eyes.

2. The driving corrective vision system for the visually impaired as claimed in claim 1 comprises:
a rear view lens;
the rear view lens comprising an attachment mechanism;
the rear view lens being removably mounted onto a rear view mirror of the vehicle through the attachment mechanism; and
the rear view lens being optically configured to position a focal point of the rear view lens at the location of the driver's eyes.

3. The driving corrective vision system for the visually impaired as claimed in claim 1 comprises:
a driver-side lens;
the driver-side lens comprising an attachment mechanism;
the driver-side lens being removably mounted onto a driver-side mirror of the vehicle through the attachment mechanism; and
the driver-side lens being optically configured to position a focal point of the driver-side lens at the location of the driver's eyes.

4. The driving corrective vision system for the visually impaired as claimed in claim 1 comprises:
a passenger side lens;
the passenger side lens comprising an attachment mechanism;
the passenger side lens being removably mounted onto a passenger side mirror of the vehicle through the attachment mechanism; and
the passenger side lens being optically configured to position a focal point of the passenger side lens at the location of the driver's eyes.

5. The driving corrective vision system for the visually impaired as claimed in claim 1, wherein the front corrective lens, the rear view lens, the driver-side lens, the passenger side lens are shatter resistant.

6. The driving corrective vision system for the visually impaired as claimed in claim 1 comprises:
wherein the front corrective lens and the driver-side visor are in a first operative configuration;
the driver-side visor being pressed against an interior roof of the vehicle; and
the front corrective lens being oriented at an optimal visibility angle to the driver-side visor.

7. The driving corrective vision system for the visually impaired as claimed in claim 6, wherein the optimal visibility angle is a right angle.

8. The driving corrective vision system for the visually impaired as claimed in claim 1 comprises:
wherein the front corrective lens and the driver-side visor are in a second operative configuration;
the driver-side visor being oriented at an offset angle from an interior roof of the vehicle; and
the front corrective lens being oriented at an optimal visibility angle to the driver-side visor.

9. The driving corrective vision system for the visually impaired as claimed in claim 8, wherein the optimal visibility angle is an angle greater than 90 degrees.

10. The driving corrective vision system for the visually impaired as claimed in claim 1 comprises:
wherein the front corrective lens and the driver-side visor are in a retracted storage configuration;
the driver-side visor being pressed against an interior roof of the vehicle; and
the front corrective lens being pressed against the driver-side visor, opposite to the interior roof of the vehicle.

11. A driving corrective vision system for the visually impaired comprises:
a front corrective lens;
a rear view lens;
a passenger side lens;
a driver-side lens;
a driver-side visor of a vehicle;
the driver-side visor comprises a horizontal rotation axis and a distal edge;
the horizontal rotation axis and the distal edge being positioned opposite to each other across the driver-side visor;
the front corrective lens being hingedly connected along the distal edge;
the front corrective lens being optically configured to position a focal point of the front corrective lens at a location of the driver's eyes;
the rear view lens being optically configured to position a focal point of the rear view lens at the location of the driver's eyes;
the driver-side lens being optically configured to position a focal point of the driver-side lens at the location of the driver's eyes; and
the passenger side lens being optically configured to position a focal point of the passenger side lens at the location of the driver's eyes.

12. The driving corrective vision system for the visually impaired as claimed in claim 11 comprises:
the rear view lens comprising an attachment mechanism; and
the rear view lens being removably mounted onto a rear view mirror of the vehicle through the attachment mechanism.

13. The driving corrective vision system for the visually impaired as claimed in claim 11 comprises:
the driver-side lens comprising an attachment mechanism; and
the driver-side lens being removably mounted onto a driver-side mirror of the vehicle through the attachment mechanism.

14. The driving corrective vision system for the visually impaired as claimed in claim 11 comprises:
the passenger side lens comprising an attachment mechanism; and
the passenger side lens being removably mounted onto a passenger side mirror of the vehicle through the attachment mechanism.

15. The driving corrective vision system for the visually impaired as claimed in claim 11, wherein the front corrective lens, the rear view lens, the driver-side lens, the passenger side lens are shatter resistant.

16. The driving corrective vision system for the visually impaired as claimed in claim 11 comprises:
wherein the front corrective lens and the driver-side visor are in a first operative configuration;
the driver-side visor being pressed against an interior roof of the vehicle; and
the front corrective lens being oriented at an optimal visibility angle to the driver-side visor.

17. The driving corrective vision system for the visually impaired as claimed in claim 16, wherein the optimal visibility angle is a right angle.

18. The driving corrective vision system for the visually impaired as claimed in claim 11 comprises:
wherein the front corrective lens and the driver-side visor are in a second operative configuration;
the driver-side visor being oriented at an offset angle from an interior roof of the vehicle; and
the front corrective lens being oriented at an optimal visibility angle to the driver-side visor.

19. The driving corrective vision system for the visually impaired as claimed in claim 18, wherein the optimal visibility angle is an angle greater than 90 degrees.

20. The driving corrective vision system for the visually impaired as claimed in claim 11 comprises:
wherein the front corrective lens and the driver-side visor are in a retracted storage configuration;
the driver-side visor being pressed against an interior roof of the vehicle; and
the front corrective lens being pressed against the driver-side visor, opposite to the interior roof of the vehicle.
